(19) United States
(12) Patent Application Publication
(10) Pub. No.: US 2011/0074119 A1
(43) Pub. Date: Mar. 31, 2011

(54) VENTING DEVICE

(76) Inventors: Brian Deane, Wilmington, DE (US); Dave DeGuiseppi, Chadds Ford, PA (US)

(21) Appl. No.: 12/570,589

(22) Filed: Sep. 30, 2009

(51) Int. Cl. F16J 15/50; F16J 15/02

(52) U.S. Cl. 277/634; 277/637

(57) ABSTRACT

A clamping assembly for venting an enclosure having openings extending from the inside of the enclosure to the outside of the enclosure, the clamping assembly having a band portion having an inside surface oriented towards the enclosure and an outside surface opposite the inside surface, the band portion having at least one hole extending therethrough from the inside surface to the outside surface of the band portion, and gas permeable and liquid impermeable venting element covering at least one hole in the band, wherein at least one hole in the band portion is at least partially aligned with an opening of the enclosure to provide a fluid path between the inside of the enclosure and the outside of the enclosure.

### FIELD OF THE INVENTION

The present invention relates to venting of enclosures, including but not limited to electronic enclosures, automotive enclosures and containers for storing and transporting liquids. Specifically, the invention is useful in venting automotive boots. Such boots may have application in sealing rotating joints, such as constant velocity (CV) joint, universal joint, drive shaft, prop shaft and driveline components (collectively, “Drive Line Joints”). In other applications, the vents may be applicable to boots used for sealing components that move in linear fashion, such as steering system components.

### BACKGROUND OF THE INVENTION

Convoluted and rolling boots have long been used to protect joints in automotive applications. Such boots contain the lubricant so that it cannot escape during operation, and to protect the joint and lubricant from external contamination. This contamination mainly consists of water and dirt encountered during driving. The boots are typically molded from TPE or Silicone Rubber materials, but materials differ depending on boot type and application conditions. The boots are typically affixed to the rotating shaft components by metal clamps. These clamps serve mechanical attachment and sealing functions and are intended to last the life of the joint and in some cases the life of the vehicle.

During normal operation of these moving components, temperature fluctuations are encountered. Elevated temperatures may occur due to both frictional and environmental conditions. Frequently the components are located in close proximity to the automobile engine and exhaust systems and these may also contribute to increased operating temperatures. Increased temperature may cause pressure to build inside the joint and in the boot. This pressure must be vented to prevent expansion which could lead to seal failure or even eventual rupture of the boot assembly. Such failures may allow escape of lubricant and ingress of contaminants, leading to premature failure of the entire joint assembly.

Previous boot designs have incorporated open vent ports into a boot design to allow for pressure relief, but such ports did not provide for adequate water protection. Water intrusion into the drive line joint contributed to lubricant degradation and ultimately joint failure. Some prior boots were designed with convolutions that formed a bellows, which allowed for minor expansion from pressure increases. However, these designs were not suitable in all applications, and in particular were not suitable for high rotational speeds. In addition to higher rotational speeds, new vehicle designs now impose more severe operating conditions, and environmental challenges including water submersion. Accordingly, prior venting devices do not meet current needs with respect to pressure venting and water protection.

### SUMMARY OF THE INVENTION

In one aspect, the invention provides a vented boot assembly for mounting on a shaft, the assembly including a boot having least one opening therein providing fluid communication between the interior of the boot and the exterior of the boot, an air permeable and liquid impermeable venting element covering one or more openings in said boot and a clamp having at least one opening aligned with at least one opening in the boot wherein the opening in the clamp and the opening in the boot provide a fluid path between the shaft and the exterior of said boot.

In another aspect, the invention provides a clamp for attaching a boot to a shaft, the clamp including a structural member for surrounding the boot and the shaft and securing the boot to the shaft, the structural member having a first surface for positioning adjacent to the boot and a second surface opposite the first surface, a passageway through the structural member for providing fluid communication through the structural member, and gas permeable and liquid impermeable venting element covering the passageway.

In a further aspect the invention provides a clamping assembly for venting an enclosure having openings extending from the inside of the enclosure to the outside of the enclosure, the clamping assembly having a band portion having an inside surface oriented towards the enclosure and an outside surface opposite the inside surface, the band portion having at least one hole extending therethrough from the inside surface to the outside surface of the band portion, and gas permeable and liquid impermeable venting element covering at least one hole in the band, wherein at least one hole in the band portion is at least partially aligned with an opening of the enclosure to provide a fluid path between the inside of the enclosure and the outside of the enclosure.

### BRIEF DESCRIPTION OF THE DRAWINGS

The advantages of the invention are more fully understood from the associated figures and descriptions.

FIGS. 1a, 1b, and 1c are perspective, cross-sectional and detail views of a first embodiment of the vented drive line joint.

FIG. 2 depicts an exploded view of a clamp incorporating vents covered and venting material such as ePTFE.

FIGS. 3a, 3b and 3c depicts a perspective, cross-sectional and detail views of another embodiment of the invention for venting a CV or other boot assembly.

FIGS. 4a, 4b and 4c depicts a perspective, cross-sectional and detail views of another embodiment of the invention for venting a CV or other boot assembly.

FIGS. 5a, 5b and 5c depicts a perspective, cross-sectional and detail views of another embodiment of the invention for venting a CV or other boot assembly.

### DESCRIPTION OF THE INVENTION

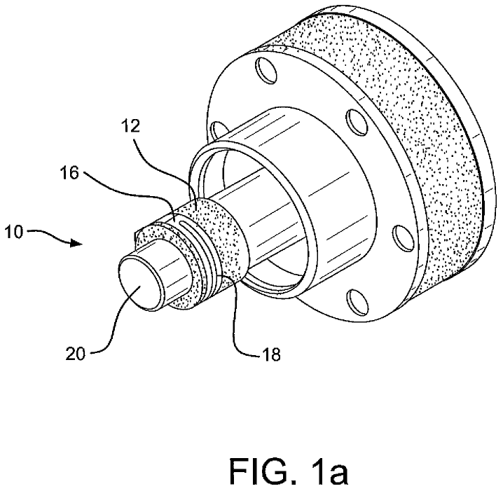

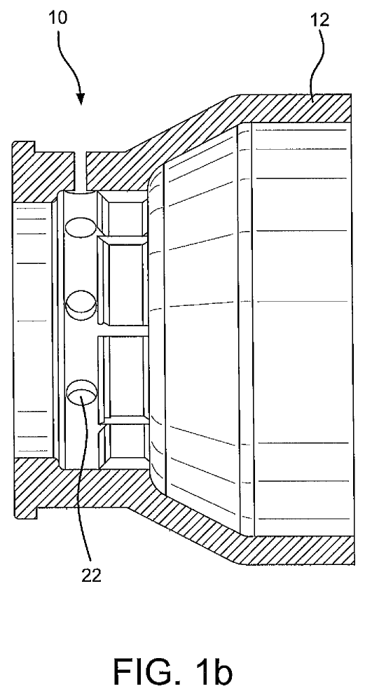

In one embodiment as described in FIGS. 1a through 1c, the invention comprises a vented boot assembly (10). The assembly is installed on a shaft (20), and comprises a boot (12) constructed of resilient materials and having holes or openings (22) therein to provide venting. The openings are covered with a venting element (14) that is air permeable and liquid impermeable. A clamp (16) is positioned over the venting element. The clamp incorporates openings or holes (18) and the clamp is positioned such that the holes in the clamp align with the holes (22) in the boot.

The boot is constructed of a resilient material. For automotive applications, such as for a Drive Line Joint, the boot may be molded from TPE or Silicone Rubber materials. Other materials like EPDM or NBR may be used and may differ depending on boot type and application conditions. The boot incorporates one or more openings to allow venting. Advantageously, openings are radial and extend from the interior of the boot to the surroundings. As shown in FIG. 1c, the boot may be constructed to incorporate one or more channels (24) within the interior surfaces of the boot to provide a gas pathway and improve venting performance. Channels may also be provided on the exterior surfaces.

The venting element may comprise any porous material that is air permeable and liquid impermeable and allows for venting, but prevents intrusion of water and other liquids. The venting element may be advantageously constructed of PTFE membrane. The PTFE material may be rendered oleophobic by methods known in the art.

The membrane may be supported by any suitable backer material where necessary. Exemplary backers may include non wovens, scrim or non woven materials laminated or affixed to the membrane. The venting element covers the openings in the boot to prevent liquid intrusion. The venting element may be formed with, or attached to the boot by suitable means such as mechanical attachment, heat welding, or ultrasonically welding or adhesive. Alternatively, the venting element may be simply positioned over the holes in the boot and attached with a clamp. Alternatively, the venting element may be attached to the clamp, such as with an adhesive and the clamp and vent element assembly assembled over the holes in the boot.

The clamp includes a band portion constructed of material sufficiently strong for its application. It must provide sufficient strength to maintain the boot onto the axle, and must provide sufficient pressure to seal the venting element over the holes in the boot and prevent slippage which could cause misalignment of the vent holes in the clamp and boot. The clamp may be constructed of metallic or polymeric materials.

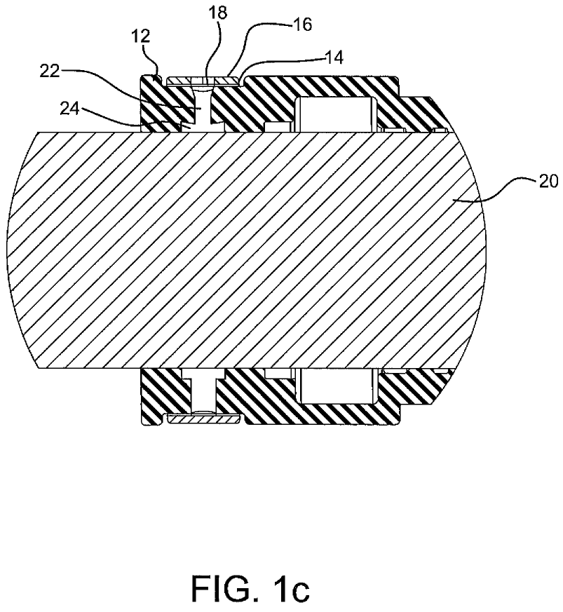

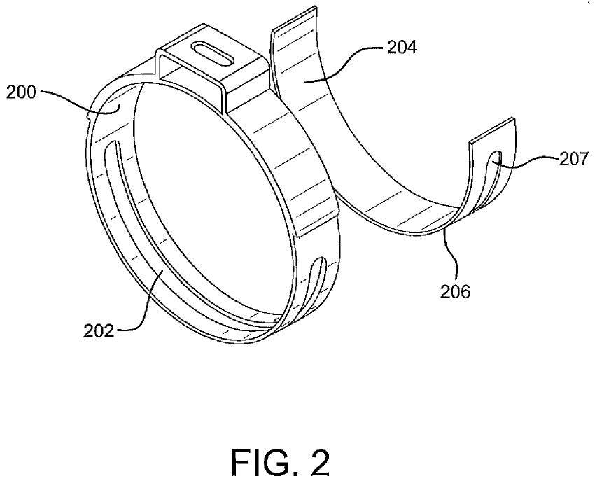

FIG. 2 depicts an exploded view of a clamp incorporating a band portion (200) having an opening (202) covered with venting material such as ePTFE (204). One side of a double sided pressure sensitive adhesive (206) is optionally attached to the clamp and the other side is attached to the ePTFE material. The adhesive may have openings (207) may allow air flow at least partially aligned with the vent openings (202). In another aspect, the adhesive may be oriented radially inward to facilitate attachment to the boot.

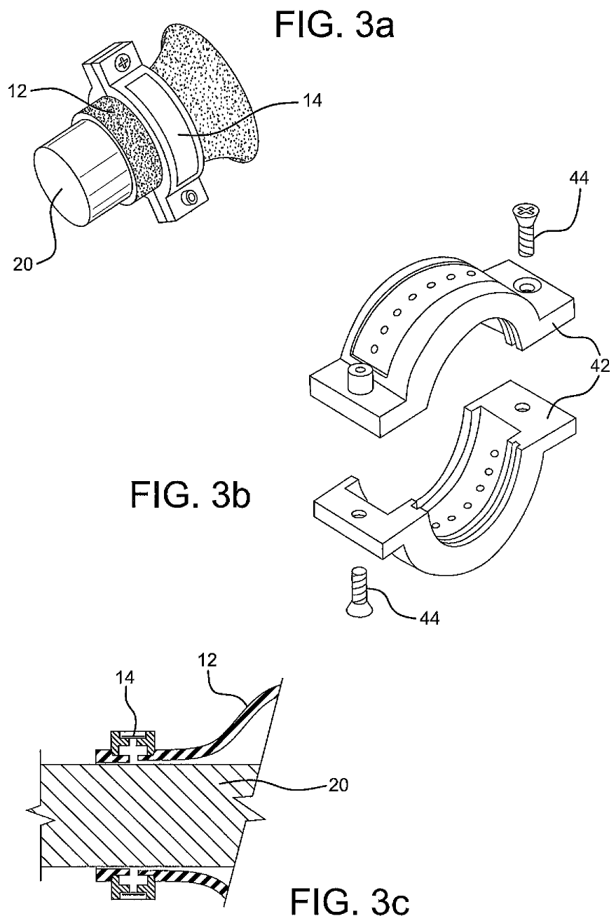

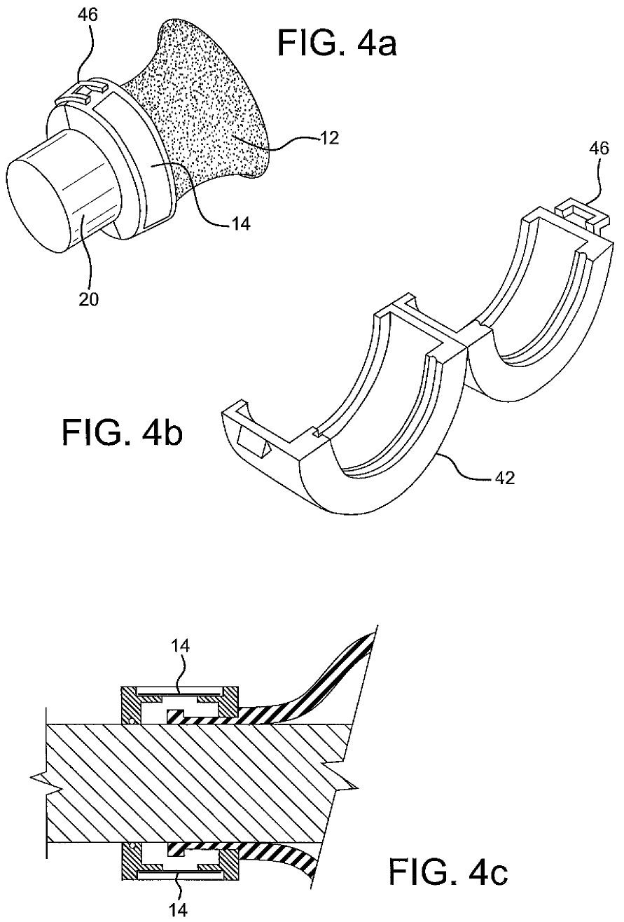

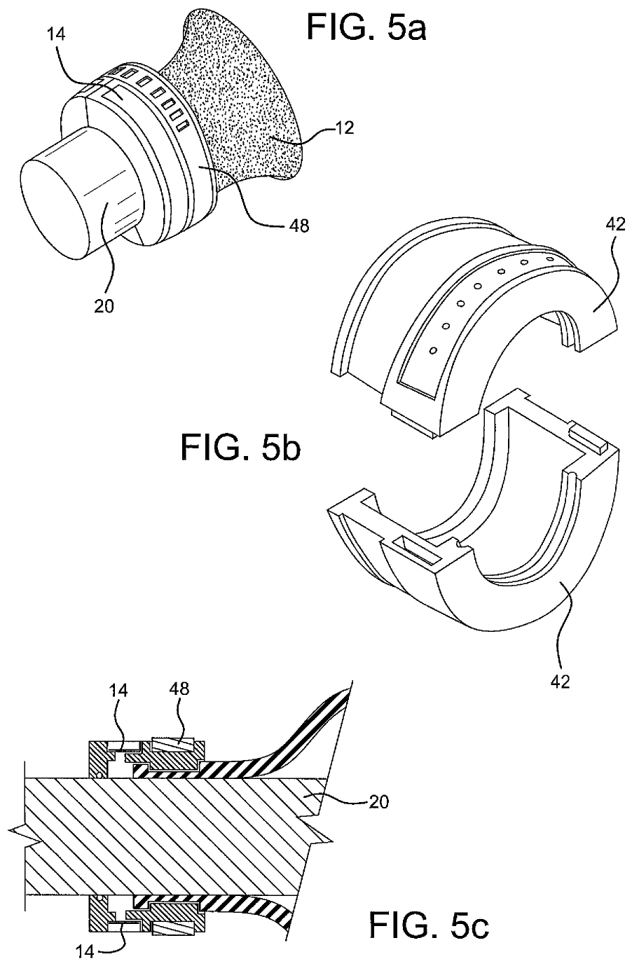

In another embodiment, described in FIGS. 3, 4 and 5, the invention includes a venting element (14) mounted to a molded or machined component assembly (42). As shown in FIGS. 3a and 3b, the venting element is mounted on the outside surface of the component assembly that is positioned over a boot and shaft interface and sealed or held in place using screws (44) or the like. As shown in FIGS. 4a and 4b, the venting element (14) is mounted on the outside surface of a hinged component assembly that is positioned over the boot and shaft interface and sealed or held in place using a locking feature (46). As shown in FIGS. 5a and 5b, the venting element may alternatively be mounted on the outside surface of a component assembly that is positioned over the boot and shaft interface and sealed or held in place using a clamp (48).

### Example

An ear clamp (Part Number: 034.6-706R, Oetiker, Inc) of width 7 mm, diameter 34.6 mm, was modified to provide an air passageway by using a metal punch to create an opening in the clamp. The width of the opening was about 2.5 mm and length was about 31 mm. An opening of width of about 3 mm and length of about 32 mm was cut into a double sided polyester pressure sensitive adhesive (PSA) tape. The PSA tape was attached to the ear clamp on one side. The opening on the PSA tape was aligned with the opening on the ear clamp. An expanded PTFE (ePTFE) membrane was attached over the opening to the other side of the double sided PSA tape. The modified ear clamp was clamped directly on to a boot (32 mm diameter at clamping interface) constructed of Silicone rubber such that the openings in the boot were aligned with the opening in the clamp. The boot had 4 openings, each of diameter 2.5 mm.

1. A vented boot assembly for mounting on a shaft, the assembly comprising:
a. a boot having least one opening therein providing fluid communication between the interior of the boot and the exterior of the boot,
b. an air permeable and liquid impermeable venting element covering one or more openings, in said boot and
c. clamp having at least one opening aligned with at least one opening in the boot wherein the opening in the clamp and the opening in the boot provide a fluid path between the shaft and the exterior of said boot.

2. The vented boot assembly of claim 1 in which said venting element comprises PTFE.

3. The vented boot assembly of claim 1 in which said venting element is oleophobic.

4. The vented boot assembly of claim 1 in which said venting element is attached to said clamp.

5. A clamp for attaching a boot to a shaft, the clamp comprising:
a. a structural member for surrounding the boot and the shaft and securing the boot to the shaft, the structural member having a first surface for positioning adjacent to the boot and a second surface opposite the first surface,
b. a passageway through the structural member for providing fluid communication through the structural member, and
c. a gas permeable and liquid impermeable venting element covering the passageway.

6. The clamp of claim 2 wherein the venting element is disposed on the interior surface of the clamp.

7. The clamp of claim 2 in which the structural member is metallic.

8. The clamp of claim 2 in which the structural member is polymeric.

9. A clamping assembly for venting an enclosure having openings extending from the inside of the enclosure to the outside of the enclosure, the clamping assembly comprising:
a. rounded band portion having an inside surface oriented towards the enclosure and an outside surface opposite the inside surface, the band portion having at least one hole extending therethrough from the inside surface to the outside surface of the band portion,
b. gas permeable and liquid impermeable venting portion disposed covering at least one hole in the band
c. wherein at least one hole in the band portion is at least partially aligned with an opening of the enclosure to provide a fluid path between the inside of the enclosure and the outside of the enclosure.
